(19) United States
(12) Patent Application Publication
(10) Pub. No.: US 2012/0302698 A1
(43) Pub. Date: Nov. 29, 2012

(54) MOISTURE-ADAPTIVE VAPOR BARRIER, IN PARTICULAR FOR HEAT INSULATING BUILDINGS AND METHOD FOR PRODUCING THE VAPOR BARRIER

(75) Inventors: Rainer Dorn, Durmersheim (DE); Birgit Boge, Mannheim (DE); Franz-Josef Kasper, Ladenburg (DE)

(73) Assignee: SAINT-GOBAIN ISOVER, Courbevoie (FR)

(21) Appl. No.: 13/514,559

(22) PCT Filed: Dec. 10, 2010
(86) PCT No.: PCT/EP2010/007539

§ 371 Date: Aug. 13, 2012

(30) Foreign Application Priority Data
Dec. 10, 2009 (DE) 10 2009 057 707.6

(51) Int. Cl. C08L 77/00; B29C 49/00; B82Y 30/00

(52) U.S. Cl. 524/606; 264/540; 977/773

(57) ABSTRACT

The invention relates to a moisture-adaptive vapor barrier, in particular for heat insulating buildings. The vapor barrier is produced from a material which has a plateau-shaped S_{d}-value curve within a range of S_{d}-values of 2-5 m of diffusion equivalent air layer thickness at a humidity of 45-58%.

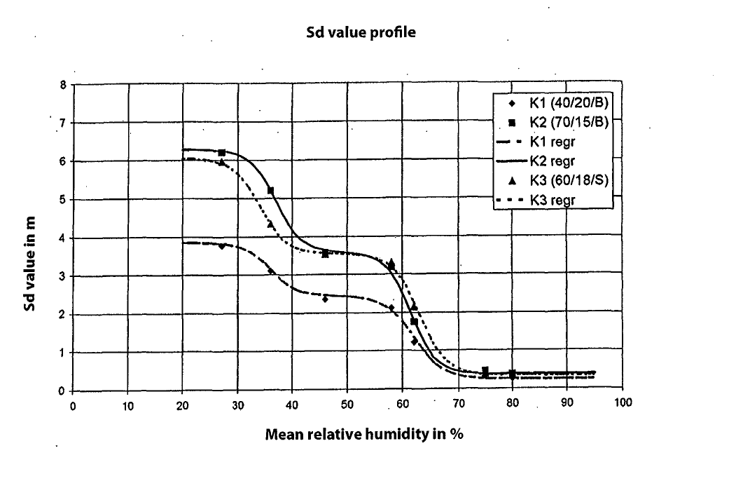

### BACKGROUND

1. Technical Field

The invention relates to a moisture adaptive vapor barrier according to the preamble of claim 1 and to a method for producing the vapor barrier.

2. Description of the Related Art

Moisture adaptive vapor barriers are characterized in that the water vapor diffusion resistance of the vapor barrier changes as a function of humidity, thus so that the water vapor diffusion resistance decreases with an increase of the humidity surrounding the vapor barrier. The water vapor diffusion resistance is thus typically measured according to DIN EN ISO 12572: 2001.

Vapor barriers of this type are mostly used for providing air tightness of buildings, thus mostly in combination with heat insulation systems for buildings. For heat insulation of buildings, in particular roofs, typically diffusion open under-webs are used below a tiled roof, below that a heat insulation layer thus from mineral wool and eventually a vapor barrier and thereunder a faring are being provided. There are two main purposes for using a vapor barrier. On the one hand side, air tightness of the roof shall be established in order to prevent penetration of cold outside air into the interior of the building and to prevent hot room air from exiting the building which prevents heat energy losses and convective moisture importation which could damage the building. On the other hand side, the vapor barrier shall have a particular barrier effect against water vapor diffusion in order to prevent undesirable moisture importation into the structure of the building.

By using so-called moisture adaptive vapor barriers which are typically provided as a foils, penetration of moisture is prevented during winter through the moisture adaptive characteristics of a foil of this type in that the vapor barrier substantially closes under wintery and thus low humidity conditions. During stronger heat irradiation in summer and thus under more humid conditions than in winter, the moisture exits from the wooden structure e.g. of a roof; the vapor barrier foil reacts as a consequence of the comparatively high humidity surrounding the vapor barrier in that the vapor barrier so to speak opens due to a reduction in water vapor diffusion resistance so that a respective drying is provided.

Polyamide is typically used as a material for moisture adaptive vapor barrier foils (c.f. DE 195 14420 C1). In this foil, the water vapor diffusion resistance is reduced with increasing mean ambient humidity. Thus, the moisture adaptive properties of this known foil vapor barrier are adjusted so that the vapor barrier for a mean ambient humidity of the atmosphere surrounding the vapor barrier of 30 to 50% has a water vapor diffusion resistance (S_{d}-value) of 2-5 m diffusion equivalent air layer thickness and for an ambient humidity in a range of 60 to 80% a water vapor diffusion resistance (S_{d}-value) which is less than 1 m. This has the consequence that a vapor barrier of this type during winter time in which typically dry conditions are provided and the relative humidity of the atmosphere surrounding the vapor barrier is essentially in a range of 30 to 50%, has a barrier effect since as a consequence of the comparatively high water vapor diffusion resistance, the vapor barrier closes, thus only little water vapor can diffuse through the foil. This prevents that significant humidity gets from the inside of buildings through the foil to the outside, for example into a wooden structure of a building roof and/or of a wall, where the moisture subsequently precipitates and can eventually lead to rotting and mildew formation.

Under humid conditions as they prevail in particular in summer months, however, a diffusion of the humidity is facilitated due to the reduced diffusion resistance. As a consequence, humidity can be removed from the wooden structure, thus a drying is facilitated so that damages in particular at the wooden structure can be prevented.

Eventually, additional vapor barrier foils with multi-layer configuration and moisture adaptive characteristics are known (DE 20 2004 019 654 U1 or DE 101 11 319 A1) which have for a relative ambient humidity of 30 to 50% a water vapor diffusion resistance S_{d} of 5 m diffusion equivalent air layer thickness and above and for a relative ambient humidity of 60 to 80% a water vapor diffusion resistance S_{d} of less than 0.5 m diffusion equivalent air layer thickness. In known humidity adaptive vapor barrier foils of this type, the water vapor diffusion resistance plotted over the mean or relative moisture develops in an S-curve with an incoming S-arm that starts from higher water vapor diffusion resistance values with lower humidity in a direction of the outgoing S-arm with reduced diffusion resistance values for a higher humidity surrounding the vapor barrier.

It is well known that the curve of the diffusion resistance plotted over humidity of the humidity adaptive vapor barriers can be adjusted through the formula S_{d}=D×μ, wherein D represents the thickness of the vapor barrier and p represents a material dependent parameter of the vapor barrier. Thus, a change of the moisture adaptive character of a vapor barrier is provided through a respective thickness adjustment in that the thickness of the vapor barrier foil is increased or reduced accordingly which does not change the S-curve pattern but only leads to a movement of the S-curve along the ordinate. This would lead for an increase of the thickness of the vapor barrier to a respective increase of the S_{d} value under dry conditions in winter and also under humid conditions in summer which would lead in such case for summer conditions to a degradation of the properties of the vapor barrier due to the drying properties that are reduced as a consequence. However, there are limits to reducing the thickness of the vapor barrier foil which is typically provided in thickness ranges between 20 μm to 80 μm due to strength and stability reasons.

Though the known vapor barrier foils have been working well under normal conditions, these are in particular dry ambient conditions as they typically occur in offices and under normal ambient conditions as they typically occur in residential buildings, however the properties of the known vapor barrier foils under increased humidity load, in particular under colder weather conditions, are quite problematic. An increased humidity load is provided in particular in rooms like large kitchens, cafeterias and similar, but also in residential and office rooms in which many plants and/or fish tanks and similar are arranged. An increased moisture load is provided in particular also in new buildings and when old buildings are remodeled due to mortar and screed application. Due to modern building materials and new building methods, construction of this type is more and more performed in the colder season, in particular in the month of October through March, thus in times when the ambient humidity reaches rather dry values under which the vapor barrier foils close under such normal conditions. When a moisture load occurs, in particular when building measures are performed in the colder season, however, for conventional vapor barriers due to the provided ambient humidity at the vapor barrier foil, an opening of the foil occurs and thus a substantially unimpeded importation of humidity through the vapor barrier foil into the wooden structure occurs which is very critical to a particular extent and which can lead to damages in the wooden construction as a consequence of mildew formation and similar.

### DETAILED DESCRIPTION

It is an object of the invention to provide a vapor barrier and a production method for a vapor barrier which considers the conditions described supra, in particular during the cold season, this means substantially prevents a critical exportation of moisture through the vapor barrier foil under a high moisture load.

The object is achieved according to the invention through the measures included in the characterizing portion of claim 1, wherein useful embodiments of the invention are characterized by the features included in the dependent claims.

According to the invention, the vapor barrier preferably provided as a foil is characterized in that it is made from a material which has a three part humidity profile, namely above a mean relative humidity of 75%, preferably 70%, and above an S_{d}-value of less than 1 m, preferably less than 0.8 m diffusion equivalent air layer thickness, then for a reduced mean humidity in a range of 45 to 58%, preferably in a range of 40 to 58%, a substantially plateau-shaped or approximately plateau-shaped curve of the S_{d}-value, wherein over this range a lower S_{d}-value of 2 m and an upper S_{d}-value of 5 m are not exceeded and the difference between the lower S_{d}-value and the upper actual S_{d}-value does not exceed 1 m in this range. For further decreasing humidity in a range of 20 to 30%, preferably 20 to 35%, the vapor barrier has an S_{d}-value which is at least 0.5 m above the upper actual S_{d}-value in the plateau shaped medium portion.

Thus, the vapor barrier foil has a small barrier effect in the range of mean humidities of greater than 75%, in particular 75% which is mandatory from a construction physical point of view; this means high drying properties in summer. Additionally, the vapor barrier foil in particular satisfies the criterion that it facilitates in rooms like in particular in large kitchens, cafeterias and similar or during construction during the cold season that a certain amount of moisture is exported under high humidity loads, but that the exportation of moisture is reduced over conventional vapor barriers, so that a critical importation of moisture into a wood structure and similar is prevented in such situations. Thus, under a high humidity load, the vapor barrier foil opens with increasing humidity in the cited range of 45 to 58% or 40 to 58%, however, the change of the S_{d}-value in this moisture range occurs only to a lesser extent than for conventional vapor barrier foils, so that a particular hold phase of the change of the S_{d}-values of the vapor barrier foil is provided in the stated range so that the S_{d}-values of the vapor barrier foil in this range only change gradually; furthermore, however, almost or approximately constant conditions are provided with respect to the S_{d}-value in this range. Preferably, the curve of the S_{d}-value over the humidity in a range of 45 to 58%, preferably 40 to 58% has an essentially plateau-shaped configuration, this means a change of the S_{d}-value in this range is kept low over a longer period of time that is determined by the increased humidity load so that on the one hand side a particular desirable blocking effect of the vapor barrier foil is maintained and by the same token for excessive humidity importation, a particular diffusion of humidity is possible without reaching a critical moisture exportation as would be the case for typical vapor barrier foils under humidity loads of this type.

The typical diagram of the S_{d}-values over the humidity values of conventional vapor barrier foils is reflected by an essentially S-shaped curve, whereas the curve is provided for the vapor barrier foil according to the invention preferably as a double S-curve, wherein the outgoing portion of the S-curve in the dry range coincides with the incoming value of the S-curve for the humid range and in a humidity range of 45 to 58% or 40 to 58%, the curve diagram is almost constant or essentially plateau shaped, this means it only includes a small change of the S_{d}-values. In an advantageous embodiment of the invention, the diagram of the curve changes within the essentially plateau shaped portion by an S_{d} differential value corresponding to the difference of the S_{d}-value when entering a humidity of 45% compared to the S_{d}-value when exiting the curve at a humidity of 58% by 0.6 m at the most, preferably by 0.4 m at the most of diffusion equivalent air layer thickness. This means the vapor barrier foil changes its S_{d}-value within this range only gradually so that a respective holding phase is reached in which the vapor barrier foil still blocks mostly, however facilitates a particular moisture exportation within the parameters already recited supra. Preferably, however, the plateau shaped diagram of the curve of the S_{d}-values over humidity is within a range of 3 to 5 m diffusion equivalent air layer thickness.

### DETAILED DESCRIPTION

According to an advantageous embodiment of the invention, the material determining the moisture adaptivity of the vapor barrier is provided in a single layer which is overall made from this material which is different from conventional vapor barrier foils in which the moisture adaptivity is determined by plural layers of a vapor barrier foil arranged on top of one another.

The plateau shaped curve of the diagram of the S_{d}-values or the described holding phase with only small changes of the S_{d}-values in the humidity range of 45 to 58% or 40 to 58% is provided by adding an additive to the base material of the vapor barrier, wherein the addition is 10 to 20%, preferably 15 to 20% by weight relative to the remaining material of the vapor barrier foil. The base material of the vapor barrier foil is preferably polyamide, wherein modified polyolefins are used as preferred additives, in particular a grafted polyethylene copolymer. Such grafted polyethylene copolymers are offered by various manufacturers. The types sold by the DuPont company under the trade name Bynel® have proven to be suitable in particular. Other preferred additives are polyethylene-polyacrylic-acid-copolymers which are also offered by several manufacturers. The types sold by the DuPont company under the trade name Surlyn® have proven particularly suitable.

The layer that accounts for the moisture adaptivity of the vapor barrier foil is characterized by a homogenous layer structure which is substantially caused by a chemical mixing of a compound of the polyamide provided in granulate form and the additive that is also provided in granulate form through melting the granulate mix, wherein granulates are formed in this melt including polyamide and additives, wherein the vapor barrier foil is then extruded from these materials or produced through a blowing method. Thus, it is advantageous that the additive in the form of nano-particles is provided within the base granulate of the additive.

According to one embodiment of the invention, vapor barrier foils can be produced with this recited moisture adaptivity in a thickness range of in particular 40 to 80 μm, preferably 50 to 70 μm. It is within the scope of the invention that this one layer vapor barrier foil with respect to the moisture adaptivity character is supplemented by additional suitable layers which are either provided for reinforcing the foil or for influencing other properties of the vapor barrier foil depending on the application.

An advantageous method for producing a vapor barrier foil of this type is characterized in that, based on granulates made from polyamide and an additive provided in granulate form, in particular polyethylene, a compound is formed through mixing. This compound made from raw materials provided in granulate form is melted in an extruder in a suitable mix ratio, optionally with adding additional additives like e.g. homogenizers with the objective to provide a homogenous melt from the base materials provided supra. A mixed granulate is produced from the homogenous melt. The mixed granulate is processed in an independent process step in an extrusion method or a blowing method to form a single layer vapor barrier foil or mono-foil according to the invention. A vapor barrier foil thus produced is characterized by a substantially homogenous structure. Alternatively, the base materials can also be processed further in a suitable extruder directly and to form a respective mono-foil. The alternative method is preferred from an economic point of view since no pre-compounding is required, however the required homogenization of the melt is hardly provided to the desired extent in a real life production environment.

The mono foil produced according to this method can be provided in a known laminating method with additional layers, in particular for improving its mechanical properties. The additional layers preferably have no impact on the humidity adaptive character of the foil according to the invention which is determined by the mono foil.

The mixing ratio of polyamide and additive is adjusted in view of the desired adaptive humidity characteristics. Thus, it has become apparent in practical trials that as a function of the individual additive which is added to a polyamide base, an addition of the additive to the polyamide base in the amount of 7 to 25% is advantageous, thus for obtaining the desired adaptive humidity characteristics according to the invention, and also with respect to the producibility of the foil. Particularly preferred is an additive mixing of the additive material in a range of 10 to 20%, in particular 14 to 18%, wherein very good results are obtained with an additive mix in a range of 15 to 18%. The upper limits of the additive mixing of the additive are in a range of 20 to 25% based on weight, wherein in view of producibility of the foil according to the invention, a threshold value of 25% by weight shall not be exceeded and the producibility of the foil is the better the more the upper range threshold moves down towards 20% and below.

Subsequently, preferred embodiments of the invention are described with reference to a single FIGURE which represents a diagram of curves of four vapor barrier foils according to the invention with respect to the S_{d}-values over the mean relative humidity, this means the ambient humidity about the vapor barrier foil.

The curve diagrams K1, K2, K3, and K4 illustrates four vapor barrier foils respectively with one layer made from polyamide, herein with the additive Bynel® 4157 at 20% by weight and a thickness of 40 μm (K1: 40 μm/20%/B), an additive content of 15% by weight Bynel for a layer thickness of 70 μm (K2: 70 μm/15%/B), an additive content of 18% by weight Surlyn 1605 with a layer thickness of 60 μm (K3: 60 μm/18%/S), or herein with the additive EVOH type H 171B, (manufacturer EVAL Europe) at 15% by weight with a layer thickness of 50 μm (K4: 50 μm/15%/EVOH).

With respect to simple producibility, the upper limits for Bynel 4157 were at approximately 22% by weight, for Surlyn 1605 at approximately 20% by weight, and for EVOH type 171B at approximately 20% by weight.

Apparently the moisture adaptivity of the vapor barrier is defined by three portions which respectively define a rectangular frame by themselves. Starting with a humidity of 75%, a rectangular portion I with S_{d}-values of less than 1 m diffusion equivalent air layer thickness is defined. In the humidity range of 45 to 58% S_{d}-values in a range of 2 to approximately 4.3 m diffusion equivalent air layer thickness are predetermined which leads to a rectangle that is defined for the portion II within which a second rectangle is defined which reflects the difference of 1 m diffusion equivalent air layer thickness at the most between the lower actual value and the upper actual value in the portion II. For a dry, low humidity in a range of 20 to 30%, the S_{d}-values of the vapor barrier foil are in an S_{d}-value range whose lower limit is at least 0.5 m above the upper actual value in the area II which defines a hatched rectangular portion III that is open in upward direction.

The humidity profile of the curve K is defined by measuring points distributed over the abscissa, wherein the measurement is performed according to DIN EN ISO 12572: 2001. It has become apparent in test series that only a small gradient should be adjusted between the humidities applied to the two sides of the vapor barrier in order to precisely define a particular measurement point in the transition portion, this means for a steeper curve diagram for known moisture adaptive vapor barriers with a single S-curve diagram for mean humidities of approximately 35 to 65% only a small gradient should be established between the two humidities applied to both sides of the vapor barrier, from which gradient the mean humidity is determined through averaging. Too large gradients lead to a corruption of the measurement values which corruption is reflected by S_{d}-values that are too small. As usual a humidity is predetermined through a salt or water; the other side is predetermined through an adjustment of a controllable climate chamber.

Table 1 summarizes the humidity settings and measurement values for the embodiments K1, K2, K3 and K4 according to the invention.

TABLE 1
Humidity conditions for S_{d}-values and S_{d}-values in m

| | | | K1 | K2 | K3 | K4 |
|---|---|---|---|---|---|---|
| | | | S_{d}- | S_{d}- | S_{d}- | S_{d}- |
| | Climate | | Value | Value | Value | Value |
| Salt | Chamber | Mean | [m] | [m] | [m] | [m] |
| Silica Gel 2% | 26% | 14% | — | — | — | 9.75 |
| Silica Gel 2% | 40% | 21% | — | — | — | 8.94 |
| Silica Gel 2% | 53% | 27.5% | 3.77 | 6.2 | 5.96 | 7.16 |
| Magnesium nitrate- | 20% | 36.5% | 3.1 | 5.2 | 4.33 | 5.67 |
| 6-hydrate: 53% | | | | | | |
| Magnesium nitrate- | 40% | 46.5% | 2.36 | 3.58 | 3.54 | 3.85 |
| 6-hydrate: 53% | | | | | | |
| Magnesium nitrate- | 62% | 57.5% | 2.12 | 3.18 | 3.3 | 3.25 |
| 6-hydrate: 53% | | | | | | |
| Sodium Chloride: | 50% | 62.5% | 1.22 | 1.75 | 2.15 | 2.74 |
| 75% | | | | | | |
| Water 100% | 50% | 75% | 0.33 | 0.47 | 0.4 | 1.84 |
| Water 100% | 60% | 80% | 0.25 | 0.38 | 0.34 | 0.24 |

The diagram of the curves K1, K2, K3 and K4 can be defined with a double S-profile, wherein the outgoing arm of the curve transitions in the dry humidity range within the portion II into the incoming arm of the S-curve for the more humid section and apparently within the portion II only a gradual reduction of the S_{d}-values is provided, so that a particular holding phase and thus a quasi-constant diagram with plateau character is provided and within this humidity range, the S_{d}-values only change gradually, this means the tendency in a direction towards opening the vapor barrier foil in the portion II is reduced accordingly. For confirming the double S-diagram, additional measuring points for low mean humidities of 14% and 21% were determined for the embodiment K4.

A double S-curve is mathematically defined by the following equation:

$$y ( x ) = \frac{A 1}{1 + {e}^{B 1 \cdot ( x - C 1 )}} + \frac{A 2}{1 + {e}^{B 2 \cdot ( x - C 2 )}} + D$$

The parameters A1/A2 represent a spreading of the two particular S-curves between minimal and maximal ordinate values, B1/B2 provide the spread of the transition portion, this means the steepness of the S-curve, C1/C2 define the position of the inflection point of the S-curves, D defines the lower threshold value.

Using the method of least mean squares for the regression, the following is obtained:

$$S = {\sum }_{i = 1}^{n} {[ {y}_{i} ( {x}_{i} ) - y ( {x}_{i} ) ]}^{2} \to min$$

$$\frac{d S}{d A 1 … D} = 2 \cdot {\sum }_{i = 1}^{n} [ [ {y}_{i} ( {x}_{i} ) - y ( {x}_{i} ) ] \cdot \frac{d y}{d A 1 … D} ] = 0 , mit$$

$$\frac{d y}{d A 1} = \frac{1}{1 + {e}^{B 1 \cdot ( {x}_{i} - C 1 )}} und \frac{d y}{d A 2} = \frac{1}{1 + {e}^{B 2 \cdot ( {x}_{i} - C 2 )}}$$

$$\frac{d y}{d B 1} = \frac{- 1}{{( 1 + {e}^{B 1 \cdot ( {x}_{i} - C 1 )} )}^{2}} \cdot ( {x}_{i} - C 1 ) \cdot {e}^{B 1 \cdot ( {x}_{i} - C 1 )} und \frac{d y}{d B 2} = \frac{- 1}{{( 1 + {e}^{B 2 \cdot ( {x}_{i} - C 2 )} )}^{2}} \cdot ( {x}_{i} - C 2 ) \cdot {e}^{B 2 \cdot ( {x}_{i} - C 2 )}$$

$$\frac{d y}{d C 1} = \frac{1}{{( 1 + {e}^{B 1 \cdot ( {x}_{i} - C 1 )} )}^{2}} \cdot B 1 \cdot {e}^{B 1 \cdot ( {x}_{i} - C 1 )} und \frac{d y}{d C 2} = \frac{1}{{( 1 + {e}^{B 2 \cdot ( {x}_{i} - C 2 )} )}^{2}} \cdot B 2 \cdot {e}^{B 2 \cdot ( {x}_{i} - C 2 )}$$

$$\frac{d y}{d D} = 1$$

Inserted, this yields 7 equations for determining the curve parameters A1 through D.

This system of equations does not have a closed solution.

$$1 ) {\sum }_{i = 1}^{n} [ [ {y}_{i} ( {x}_{i} ) - ( \frac{A 1}{1 + {e}^{B 1 \cdot ( {x}_{i} - C 1 )}} + \frac{A 2}{1 + {e}^{B 2 \cdot ( {x}_{i} - C 2 )}} + D ) ] \cdot \frac{1}{1 + {e}^{B 1 \cdot ( {x}_{i} - C 1 )}} ] = 0 \\ 2 ) {\sum }_{i = 1}^{n} [ [ {y}_{i} ( {x}_{i} ) - ( \frac{A 1}{1 + {e}^{B 1 \cdot ( {x}_{i} - C 1 )}} + \frac{A 2}{1 + {e}^{B 2 \cdot ( {x}_{i} - C 2 )}} + D ) ] \cdot \frac{1}{1 + {e}^{B 2 \cdot ( {x}_{i} - C 2 )}} ] = 0 \\ 3 ) {\sum }_{i = 1}^{n} [ [ {y}_{i} ( {x}_{i} ) - ( \frac{A 1}{1 + {e}^{B 1 \cdot ( {x}_{i} - C 1 )}} + \frac{A 2}{1 + {e}^{B 2 \cdot ( {x}_{i} - C 2 )}} + D ) ] \cdot \frac{- 1}{{( 1 + {e}^{B 1 \cdot ( {x}_{i} - C 1 )} )}^{2}} \cdot ( {x}_{i} - C 1 ) \cdot {e}^{B 1 \cdot ( {x}_{i} - C 1 )} ] = 0 \\ 4 ) {\sum }_{i = 1}^{n} [ [ {y}_{i} ( {x}_{i} ) - ( \frac{A 1}{1 + {e}^{B 1 \cdot ( {x}_{i} - C 1 )}} + \frac{A 2}{1 + {e}^{B 2 \cdot ( {x}_{i} - C 2 )}} + D ) ] \cdot \frac{- 1}{{( 1 + {e}^{B 2 \cdot ( {x}_{i} - C 2 )} )}^{2}} \cdot ( {x}_{i} - C 2 ) \cdot {e}^{B 2 \cdot ( {x}_{i} - C 2 )} ] = 0 \\ 5 ) {\sum }_{i = 1}^{n} [ [ {y}_{i} ( {x}_{i} ) - ( \frac{A 1}{1 + {e}^{B 1 \cdot ( {x}_{i} - C 1 )}} + \frac{A 2}{1 + {e}^{B 2 \cdot ( {x}_{i} - C 2 )}} + D ) ] \cdot \frac{1}{{( 1 + {e}^{B 2 \cdot ( {x}_{i} - C 2 )} )}^{2}} \cdot B 2 \cdot {e}^{B 2 \cdot ( {x}_{i} - C 2 )} ] = 0 \\ 6 ) {\sum }_{i = 1}^{n} [ [ {y}_{i} ( {x}_{i} ) - ( \frac{A 1}{1 + {e}^{B 1 \cdot ( {x}_{i} - C 1 )}} + \frac{A 2}{1 + {e}^{B 2 \cdot ( {x}_{i} - C 2 )}} + D ) ] \cdot \frac{1}{{( 1 + {e}^{B 2 \cdot ( {x}_{i} - C 2 )} )}^{2}} \cdot B 2 \cdot {e}^{B 2 \cdot ( {x}_{i} - C 2 )} ] = 0 \\ 7 ) {\sum }_{i = 1}^{n} [ {y}_{i} ( {x}_{i} ) - ( \frac{A 1}{1 + {e}^{B 1 \cdot ( {x}_{i} - C 1 )}} + \frac{A 2}{1 + {e}^{B 2 \cdot ( {x}_{i} - C 2 )}} + D ) ] = 0$$

This system of equations does not have a closed solution. Typically it is computed through an iterative method starting with suitable start values. For the three curves K1, K2, K3, the following values are obtained as “best fit”.

| | A1 | A2 | B1 | B2 | C1 | C2 | D |
|---|---|---|---|---|---|---|---|
| K1 | 3.5 | 2.0 | 0.20 | 0.48 | 25 | 62 | 0.29 |
| K2 | 6.3 | 3.2 | 0.23 | 0.44 | 25 | 62 | 0.36 |
| K3 | 2.5 | 3.2 | 0.4 | 0.41 | 34 | 63 | 0.35 |
| K4 | 6.7 | 3.3 | 0.15 | 0.5 | 30 | 62 | 0.2 |
| Iteration step | 0.1 | 0.1 | 0.01 | 0.01 | 0.5 | 0.5 | 0.01 |

As apparent from the embodiments, the diagram of the curve K can certainly influenced by the layer thickness and a respective mix-in of the additive, wherein as recited supra, preferably Bynel®, e.g. Bynel® 4157, or Surlyn®, e.g. Surlyn® 1605, or EVOH, e.g. H171B is used.

The vapor barrier foils K1 and K2 were produced from a granulate mix including polyamide with approximately 15% or 20% Bynel® 4157, wherein this granulate mix is melted and from the melt in turn a granulate is formed including a mix of polyamide and Bynel® 4157. From this granulate, then a vapor barrier foil with a thickness of 70 μm or 40 μm was produced through conventional extrusion in an extruder. The production of the vapor barrier foil K3 was performed analogously by adding 18% Surlyn® 1605. A product thickness of 60 μm was produced. The vapor barrier foil K4 was produced from a mixture of polyamide with an addition of 15 EVOH H171B in an extruder with a connected slot nozzle. A product thickness of 50 μm was produced.

In all embodiments a polyamide 6 was used, thus the type B40L (manufacturer BASF). Field trials have shown that the vapor barrier foils according to the invention under humid conditions as they are provided during new construction or remodeling still develop a desired barrier effect in the critical humidity range of 45 to 60% and only open slightly in the recited range so that over a longer time period, a substantially even moisture exportation is provided by the vapor barrier foil, wherein the vapor exportation does not damage the wooden structure.

1. A moisture adaptive vapor barrier for use in heat insulation of buildings comprising:
a material having a water vapor diffusion resistance S_{d}-value expressed as an diffusion equivalent air layer thickness which increases with a decrease of a humidity surrounding the moisture adaptive vapor barrier to form a diagram of a curve of the S_{d} value over a mean relative humidity, wherein the moisture adaptive vapor barrier in a first range starting with the mean relative humidity of about 70% and above, has an S_{d}-value of less than about 1 m and
wherein the moisture adaptive vapor barrier for the mean relative humidity in a second of about 40 to 58%, has a generally plateau-shaped diagram for the S_{d}-value, wherein, over this range, a lower S_{d}-value of about 2 m is not undercut and an upper S_{d}-value of about 5 m is not exceeded, and the difference between the upper and the lower S_{d}-value does not exceed 1 m, and
wherein for the mean relative humidity for a third range of about 20 to 35%, the S_{d}-value is at least about 0.5 m above the upper S_{d}-value of the second range.

2. The moisture adaptive vapor barrier according to claim 1, wherein, within the second range, the lower S_{d}-value is about 3 m or more.

3. The moisture adaptive vapor barrier according to claim 1, or wherein the diagram of the curve changes within the generally plateau-shaped diagram of the second range (II) by an S_{d} differential value of about 0.6 m at the most, wherein the S_{d} differential is a difference between the upper S_{d}-value and the lower S_{d}-value.

4. The moisture adaptive vapor barrier according to claim 1, wherein, within the first range, the S_{d}-values is below about 0.5 m.

5. The moisture adaptive vapor barrier according to claim 1, wherein the diagram of the curve is generally shaped as a double S-curve, and wherein, the plateau-shaped portion is generally arranged in a transition portion of the joined S-curves.

6. The moisture adaptive vapor barrier according to claim 1, wherein the material defining the humidity adaptivity of the moisture adaptive vapor barrier is provided in a single layer.

7. The moisture adaptive vapor barrier according to claim 1, wherein the material of the moisture adaptive vapor barrier is formed from polyamide and an additive.

8. The moisture adaptive vapor barrier according to claim 7, wherein a percentage of the additive in the material of the layer is about 7 to 25% by weight of the polyamide.

9. The vapor barrier according to claim 7, wherein the additive is formed by a modified polyolefin.

10. The moisture adaptive vapor barrier according to claim 6, wherein the material of the layer is formed from polyamide granulates and an additive provided in granulate form, wherein the polyamide granulates and the additive granulates after mixing are extruded to form a foil layer such that the material of the layer forms an essentially homogenous layer structure.

11. The moisture adaptive vapor barrier according to claim 6, wherein the material of the layer is formed from polyamide granulates and an additive provided in the form of granulates, which is mixed to form a compound, the compound chemically mixed and formed into a granulates melt, the granulate melt is further extruded or blown into a foil layer, such that the material of the layer forms an essentially homogenous layer structure.

12. The moisture adaptive vapor barrier according to claim 7, wherein the additive is provided in the form of a nano-particles within a base granulate of the additive.

13. The moisture adaptive vapor barrier according to claim 1, wherein a material layer of the moisture adaptive vapor barrier is formed by a foil with a thickness of 40 to 80 μm.

14. A method for producing a moisture adaptive vapor barrier according to claim 1, the method comprising:
mixing a polyamide granulate with an additive granulate to form a mix; and
forming the moisture adaptive vapor barrier through the mix via an extrusion or through a blowing method.

15. The method according to claim 14, further comprising melting the mix for chemical mixing prior to forming, such that a granulates including a mixed polyamide and an additive is formed from the melt and the moisture adaptive vapor barrier is formed from the granulates through extrusion or through a blowing method.

16. The method according to claim 14, wherein the additive is provided in the form of a nano particle size within a base granulate of the additive.

17. The method according to claim 14, wherein the moisture adaptive vapor barrier is formed into a foil with a homogenous mixing structure including the polyamide and the additive.

18. The moisture adaptive vapor barrier of claim 7 wherein a percentage of the additive in the material of the layer is about 10 to 20% of the polyamide weight.

19. The moisture adaptive vapor barrier of claim 7 wherein a percentage of the additive in the material of the layer is about 14 to 18% of the polyamide weight.

20. The moisture adaptive vapor barrier of claim 9 wherein the modified polyolefin is a grafted polyethylene.

21. The moisture adaptive vapor barrier of claim 9 wherein the additive is formed by a polyethylene polyacrylic acid copolymer.

22. A moisture adaptive vapor barrier for use in heat insulation of buildings having at least a three part humidity profile, the moisture adaptive vapor barrier comprising:
a first profile wherein a plot of a water vapor diffusion resistance S_{d}-value against a mean relative humidity in a first range of the mean relative humidity of about 70% and above, has an S_{d}-value of less than about 1 m;
a second profile wherein a plot of a water vapor diffusion resistance S_{d}-value against a mean relative humidity in a second range of the mean relative humidity of about 40 to 58%, has a generally plateau-shaped diagram, the S_{d}-value having an upper S_{d}-value of about 5 m or less and a lower S_{d}-value of about 2 m or more, and wherein, the difference between the upper S_{d}-value and the lower S_{d}-value being about 1 m or less; and
a third profile wherein a plot of a water vapor diffusion resistance S_{d}-value against a mean relative humidity in a third range of the mean relative humidity of about 20 to 35%, has an S_{d}-value that is at least about 0.5 m above the upper S_{d}-value of the second range.
